(19) United States
(12) Patent Application Publication
(10) Pub. No.: US 2024/0306593 A1
(43) Pub. Date: Sep. 19, 2024

(54) PET-USE ABSORBENT SHEET

(71) Applicant: Kocho Co., Ltd., Fuji (JP)

(72) Inventor: Kunihiko WATANABE, Fuji (JP)

(73) Assignee: Kocho Co., Ltd., Fuji (JP)

(21) Appl. No.: 18/604,478

(22) Filed: Mar. 13, 2024

(30) Foreign Application Priority Data
Mar. 14, 2023 (JP) 2023-039559

(51) Int. Cl. A01K 1/01

(52) U.S. Cl. CPC A01K 1/0107

(57) ABSTRACT

A pet-use absorbent sheet according to the present invention includes: a liquid-permeable top side layer; a liquid-impermeable backside layer; an absorption member arranged between the top side layer and the backside layer and configured to absorb a liquid that permeated through the top side layer; and a tissue layer arranged between the top side layer and the absorption member. An unevenness part is formed to a portion where the tissue layer covers the absorption member, the absorption member contains a pulp material and a water-absorbent polymer material, and the ratio of the weight of the water-absorbent polymer material to the weight of the pulp material in the absorption member is less than 1.

### TECHNICAL FIELD

The present invention relates to a pet-use absorbent sheet.

### BACKGROUND ART

In recent years, many types of pets such as dogs, cats, rabbits, or the like are kept indoor, and pet-use absorbent sheets for absorbing urine from such pets or the like are widely used. In indoor pet keeping, pet supplies that have excellent absorbability of urine and can suppress odors generated from urine are desired.

Patent Literature 1 discloses a pet-use absorbent sheet in which an absorber portion for absorbing urine has a two-layered structure formed of the upper layer and the lower layer with different properties from each other to increase the capability of retaining urine or increase the urine absorption rate.

### CITATION LIST

### Patent Literature

[PTL 1]

Japanese Patent Application Publication No. 2009-232684

### SUMMARY OF INVENTION

### Technical Problem

After a pet urinated on a pet-use absorbent sheet, if urine remains on the top of the sheet or dampness remains on the top side layer that may be in direct contact with the pet, moisture or dirt may attach to soles of the pet walking on such an area of the sheet. If the pet with wet soles moves out of the sheet and walks around in the room, the dirt will spread in the room. Thus, there is a demand for a pet-use absorbent sheet that can more quickly absorb and diffuse urine or moisture therein and suppress soles of a pet from getting wet. Further, in terms of reducing the amount of waste or saving resources, it is desirable for a pet-use absorbent sheet to be used multiple times rather than being disposed for one time urination.

The present invention has been made in view of such circumstances, and an object thereof is to provide a pet-use absorbent sheet that can suppress soles of a pet from getting wet and can be used multiple times.

### Solution to Problem

To achieve the above object, the pet-use absorbent sheet of the present invention employs the following solutions.

The pet-use absorbent sheet according to one aspect of the present invention includes: a liquid-permeable top side layer; a liquid-impermeable backside layer; an absorption member arranged between the top side layer and the backside layer and configured to absorb a liquid that permeated through the top side layer; and a tissue layer arranged between the top side layer and the absorption member, a portion where the tissue layer covers the absorption member has an unevenness part, the absorption member contains a pulp material and a water-absorbent polymer material, and the ratio of the weight of the water-absorbent polymer material to the weight of the pulp material in the absorption member is less than 1.

The unevenness part is formed to the portion where the top side layer and the tissue layer cover the absorption member. Accordingly, even after multiple times of liquid absorption, the liquid is diffused wider over the absorption member, and dry texture of the top side layer can be maintained. Further, even after the pet-use absorbent sheet has repeatedly absorbed the liquid not only once but also twice or three times, an absorption rate not different from the absorption rate exerted at the first absorption can be maintained.

The ratio of the weight of the water-absorbent polymer material to the weight of the pulp material in the absorption member is less than 1. Compared to a case where the ratio of the weight of the water-absorbent polymer material to the weight of the pulp material in the absorption member is greater than or equal to 1, the pet-use absorbent sheet of the present invention enables wider range diffusion of the liquid even with a less amount of the water-absorbent polymer per product and can suppress wetback even after multiple times of use. Further, a liquid is less likely to remain on the top side layer, and the mark of the liquid absorbed can be made less noticeable.

In the pet-use absorbent sheet according to the above aspect, the unevenness part is formed of a recess and a protrusion, and the recess is configured to allow a liquid to flow in the recess.

A liquid that has permeated through the top side layer and absorbed in the sheet is guided to the recess of the unevenness part formed in the absorption member and then diffused in the absorption member. Accordingly, even after the sheet has absorbed a liquid multiple times, the liquid can be diffused over substantially the same range as the range where the liquid was first diffused.

In the pet-use absorbent sheet according to the above aspect, a tissue layer may be further arranged between the absorption member and the backside layer.

Since another tissue layer is further arranged between the absorption member and the backside layer in the pet-use absorbent sheet, the amount of a liquid absorbed inside the sheet can be increased. Accordingly, dampness on the top side of the sheet can be quickly reduced, and dry texture of the top side layer can be maintained.

### Advantageous Effects of Invention

With the configuration described above, the pet-use absorbent sheet according to the present invention can suppress soles of a pet from getting wet and can be used multiple times.

### BRIEF DESCRIPTION OF DRAWINGS

FIG. 1 is a plan view of a pet-use absorbent sheet according to one embodiment of the present invention.

FIG. 2A is a partial enlarged sectional view of the pet-use absorbent sheet according to one embodiment of the present invention.

FIG. 2B is an enlarged view of the part X of FIG. 2A.

FIG. 3 is a graph representing comparison between the pet-use absorbent sheet according to one embodiment of the present invention and an absorbent sheet of a control product for the diffusion rate of moisture added to the sheet.

FIG. 4 is a graph representing comparison between the pet-use absorbent sheet according to one embodiment of the present invention and an absorbent sheet of a control product for the wetback amount of moisture added to the sheet.

FIG. 5 is a graph illustrating comparison between the pet-use absorbent sheet according to one embodiment of the present invention and an absorbent sheet of a control product for the wetback amount of moisture added to the sheet.

FIG. 6 is a graph illustrating comparison between the pet-use absorbent sheet according to one embodiment of the present invention and an absorbent sheet of a control product for the diffusion rate of moisture added to the sheet.

### DESCRIPTION OF EMBODIMENTS

One embodiment of the pet-use absorbent sheet according to the present invention will be described with reference to the drawings. The pet-use absorbent sheet is used for pets kept indoor, such as a dog, a cat, a rabbit, a hamster, or the like.

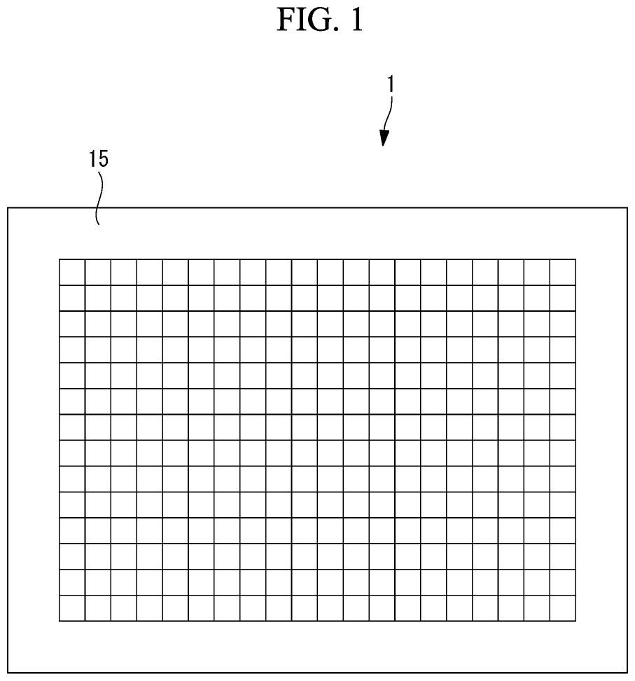

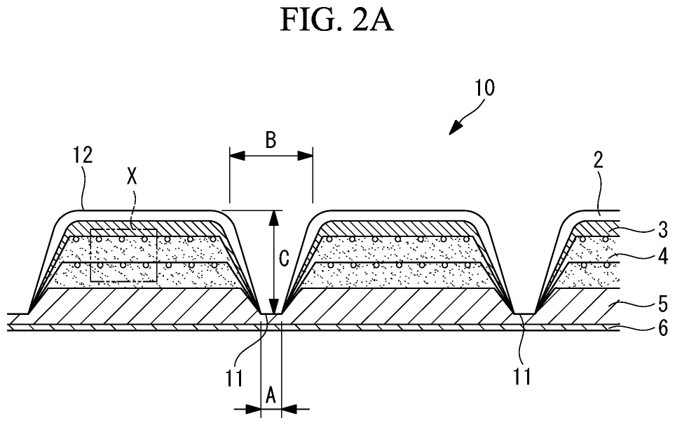

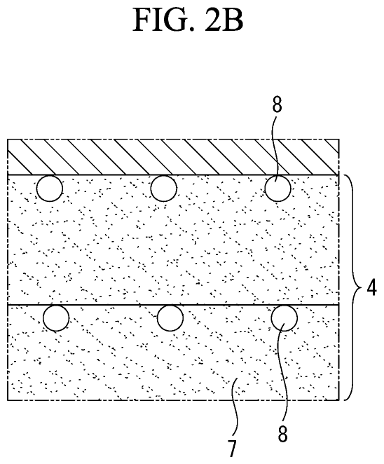

The first embodiment of the present invention will be described below with reference to FIG. 1, FIG. 2A, and FIG. 2B. FIG. 1 illustrates a pet-use absorbent sheet 1. The pet-use absorbent sheet 1 is placed spread on a floor surface of an area where a pet is kept, a tray portion of a toilet for a pet (not illustrated), a plastic sheet, or the like.

FIG. 1 illustrates an example in which the shape of the pet-use absorbent sheet 1 spread out in a planar state is rectangular. The shape of the pet-use absorbent sheet may be a square without being limited to a rectangle. The size of the pet-use absorbent sheet can be selected as appropriate based on the body size of a pet associated with the use of the sheet.

FIG. 2A illustrates a partial enlarged sectional view of the pet-use absorbent sheet 1. The pet-use absorbent sheet 1 has a configuration such that a top side sheet (top side layer) 2, a tissue (tissue layer) 3, an absorption member 4, a tissue (tissue layer) 5, and a backside sheet (backside layer) 6 are layered in this order from the top in FIG. 2A.

The top side sheet 2 is a liquid-permeable sheet-like member arranged on the most top side of the pet-use absorbent sheet, and a nonwoven fabric with or without pores, a porous plastic film, or the like may be used. In the present embodiment, a nonwoven fabric is used as the top side sheet 2. As the nonwoven fabric used for the top side sheet 2, a spunbonded nonwoven fabric, a spun-lace nonwoven fabric, a thermal-bonded nonwoven fabric, or the like may be used alone or in combination. As the material of the nonwoven fabric, polypropylene, polyethylene, or polyethylene terephthalate may be used alone or in combination.

The tissue 3 is hydrophilic absorbent paper, has substantially the same size as the absorption member 4 in planar view, and is arranged so as to cover the absorption member 4. The tissue 3 has a function of quickly transferring, to the absorption member 4, a liquid that has permeated through the top side sheet 2 and then diffusing the liquid. This function increases the absorption rate of the liquid into the absorption member 4 and can prevent soles of a pet walking on a urinated area from getting wet. As the tissue 3, for example, a tissue colored in light blue, green, or black may be used without being limited to a white tissue. With the use of a colored tissue, the mark of a liquid absorbed in the absorption member 4 can be made less visible on the top of the top side sheet to improve the appearance.

The absorption member 4 contains pulp materials 7 and water-absorbent polymer materials 8 and has a function of absorbing and retaining a liquid included in a pet manure or the like. FIG. 2B illustrates a partial enlarged sectional view of the absorption member 4 formed of cotton-like pulp materials 7 and granular water-absorbent polymer materials 8 as an example. In this example, the absorption member 4 has a configuration such that two layers of sheets made of pulp materials are arranged and the water-absorbent polymer materials 8 are dispersed between the lower pulp material sheet (inclusive) and the upper pulp material sheet and between the tissue 3 and the upper pulp material sheet (inclusive). Another example of the absorption member may be configured such that only a single layer of the sheet made of the pulp material is provided and grains of the water-absorbent polymer materials 8 are arranged dispersed inside the cotton-like pulp material.

The material forming the absorption member 4 is not limited to those described above, and crushed pulp pieces may be used as the pulp material, for example. The water-absorbent polymer material 8 can be selected from cross-linked carboxymethyl cellulose, polyacrylic acid and a salt thereof, cross-linked acrylate polymer, cross-linked polyoxyethylene, or a water-absorbent resin such as starch-based resins. In the present embodiment, cross-linked acrylate polymer is used.

In the example illustrated in FIG. 1 and FIG. 2A, the tissue 5 is also arranged between the absorption member 4 and the backside sheet 6. The material of the tissue 5 may be the same as that of the tissue 3 described previously or can be a different material therefrom. For example, a colored tissue may be used as the tissue 3, and a white tissue may be used as the tissue 5. When the tissue 5 is arranged between the absorption member 4 and the backside sheet 6, a part of a liquid that has been absorbed in the absorption member 4 and then permeated therethrough can be further retained in the tissue 5.

As a modified example of the pet-use absorbent sheet, a configuration without the tissue 5 being arranged is also possible.

The backside sheet 6 is a liquid-impermeable film-like or sheet-like member made of a synthetic resin that prevents a liquid absorbed and retained in the absorption member 4 from leaking out of the sheet. The backside sheet 6 is placed on a floor surface or on a tray. As the material of the backside sheet 6, polyethylene, polyethylene terephthalate, polypropylene, unsaturated polyester, or the like may be used. In the present embodiment, a polyethylene sheet is used as the backside sheet 6.

An unevenness part 10 as illustrated in FIG. 2A is provided to the tissue 3, the absorption member 4, and the tissue 5 of the pet-use absorbent sheet 1 of the present embodiment. This unevenness part 10 is formed of recesses 11 and protrusions 12.

In the example illustrated in FIG. 1 and FIG. 2A, the unevenness part 10 is an embossed part formed by embossing and is provided in a lattice pattern over the entire surface covering the absorption member 4. As illustrated in FIG. 2A, the protrusion 12 in the present embodiment has a shape protruding substantially prismatically in sectional view, and the recess 11 is groove-shaped. The shape of the protrusion 12 is not limited to the above and can be formed as a protrusion shape such as a ridged shape or a convex strip as well as a pyramidal, cylindrical, or conical shape. Each recess 11 is formed in a groove shape continuously extending between adjacent protrusions 12. The linear portions forming the lattice in FIG. 1 correspond to the recesses 11, and the portions surrounded by these recesses 11 correspond to the protrusions 12.

In the pet-use absorbent sheet 1 of the present embodiment, when the unevenness part 10 has been formed by embossing as illustrated with the partial sectional view in FIG. 2A, the tissue 3 and the absorption member 4 have been crimped to the tissue 5, and thereby the tissue 3, the absorption member 4, and the tissue 5 have been integrated. The continuously extending linear grooves formed by the crimping are the recesses 11. The crimping of the tissue 3, the absorption member 4, and the tissue 5 can be performed by pressing a roll thereagainst where an embossing mold machined in a predetermined shape is mounted on the roll. The embossed feature is not limited to the lattice shape and may be provided to draw a predetermined pattern as long as an amount of the unevenness part required for absorption and diffusion of a liquid can be ensured.

Once the tissue 3, the absorption member 4, and the tissue 5 are integrated by crimping, the pulp materials 7 and the water-absorbent polymer materials 8 contained in the absorption member 4 are fixed along the recesses 11. This can prevent the pulp materials 7 and the water-absorbent polymer materials 8 from being located in an unbalanced manner and thereby prevent occurrence of a less absorbing portion even when a pet walks around on the sheet.

An adhesive agent or a glue is applied between the backside sheet 6 and one face of the tissue 5, and this one face is on the side not in contact with the absorption member 4 of the laminate in which the tissue 3, the absorption member 4, and the tissue 5 are integrated and the unevenness part 10 is formed, and a predetermined pressure is then applied to adhere the laminate and the backside sheet 6 to each other. An adhesive agent is also sprayed or applied between the top side sheet 2 and the laminate of the tissue 3, the absorption member 4, and the tissue 5. The top side sheet 2, the laminate, and the backside sheet 6 are then joined to each other. Accordingly, the pet-use absorbent sheet 1 containing the tissue 3, the absorption member 4, and the tissue 5 is manufactured. A hot-melt type adhesive agent is preferred for the adhesive agent. When the top side sheet 2, the laminate, and the backside sheet 6 are joined, the top side sheet 2 may be attached to the top side so as to fit along the recesses 11 and the protrusions 12 of the unevenness part 10, and thereby unevenness along the shape of the unevenness part 10 may also be formed in the top side sheet 2 as illustrated in FIG. 2A.

The top side sheet 2 and the backside sheet 6 may have larger edges than the tissue 3, the absorption member 4, and the tissue 5 and provide an edge part 15. FIG. 1 illustrates an example in which the edge part 15 is provided along four sides of the rectangle. Since neither absorption member nor tissue is contained in the portion where the edge part of the top side sheet and the edge part of the backside sheet overlap, it is possible for the user to avoid contact with an excreted portion by holding the edge part 15 when disposing a used pet-use absorbent sheet. Further, when a slit or an opening is provided in the edge part 15, the sheet can be mounted and fixed to a protrusion provided to a holder or a tray.

As a modified example of the unevenness part 10, instead of the unevenness part 10 being provided to the entire surface of the absorption member 4, the surface may have a portion where no unevenness part is provided. In such a case, it is possible to effectively diffuse a liquid if the unevenness part 10 is provided in the area range about 80% to 90% of the entire surface of the absorption member 4.

The formed and linearly extending recesses 11 guide and diffuse a liquid along the recesses 11 in the directions in which the recesses 11 extend. Because the recesses 11 are continuously arranged and thereby function as conduits, the liquid flows over a wide range of the absorption member 4. Accordingly, even when multiple times of urination take place at the same place or an overlapping place, the liquid is quickly diffused, and occurrence of leakage and return (wetback) can be suppressed. In contrast, with a pet-use absorbent sheet without the unevenness part being provided, quick diffusion of a liquid does not occur, and retention of the liquid in a urinated portion, that is, spot absorption will occur. If such spot absorption occurs and a liquid is retained in a narrow range, this will cause soles of the pet to get wet and lead to the pet making the room dirty.

The depth of the recess 11 (reference “C” in FIG. 2A) and the widths thereof (reference “A” and reference “B” in FIG. 2A) are set so that a liquid can flow therein. For pitches of the unevenness part 10 (sizes in the vertical and horizontal directions for one lattice in FIG. 1), the sizes that may be taken are determined in accordance with the size or the material of the bet-use absorbent sheet 1. For example, in a case of a sheet in which the portion provided with the absorption member 4 is a rectangle having a size of about 300 mm (vertical) by 400 mm (horizontal), both the pitch in the up-down direction (vertical direction) and the pitch in the left-right direction (horizontal direction) in the drawing sheet of FIG. 1 may be about 5 mm to 10 mm. It is preferable to set both the pitches in the vertical direction and the horizontal direction to 7 mm.

The unevenness part 10 is provided to at least the tissue 3 and the absorption member 4 and formed to be crimped to the sheet material arranged on the most backside. In the example described above, the tissue 3 and the absorption member 4 are crimped to the tissue 5. In a modified example with a configuration without the tissue 5 being arranged, the tissue 3 and the absorption member 4 are crimped to the backside sheet 6.

A modified example of the present embodiment may be of a configuration in which the top side sheet 2, the tissue 3, and the absorption member 4 are crimped to the tissue 5 by embossing to form the unevenness part 10. With such a configuration, a liquid flows in the recesses 11 formed also in the top side sheet 2 by embossing, and the liquid can be diffused to a wide range on the most top side more quickly before reaching the tissue 3 and the absorption member 4 contained in the pet-use absorbent sheet 1.

A further modified example may be of a configuration without the unevenness part 10 being provided to the top side sheet 2, that is, a configuration in which the laminate of the tissue 3, the absorption member 4, and the tissue 5 crimped and integrated together and having the unevenness part 10 formed thereto is covered with the top side sheet 2 from above and the top side sheet 2 and the laminate are partially adhered to each other by an adhesive agent.

In the pet-use absorbent sheet 1 of the present embodiment, the ratio of the weight of the water-absorbent polymer materials to the weight of the pulp materials contained in the absorption member 4 is less than 1. In the pet-use absorbent sheet of the present embodiment, the ratio of the weight of the water-absorbent polymer materials to the weight of the pulp materials may be less than 0.5. In contrast, in a reference example having a member corresponding to an absorption member similarly containing the pulp materials and the water-absorbent polymer materials, the ratio of the weight of the water-absorbent polymer materials to the weight of the pulp materials is 1 or greater. Although details will be described later, in the pet-use absorbent sheet of the present application, while the content of the water-absorbent polymer materials per product is less by about 30 to 40% than that in the reference example, the area of the diffusion range of a liquid taken in the sheet is larger than that in the reference example, and the wetback amount is also less than that in the reference example.

According to the present embodiment, the following effects and advantages are achieved.

In the pet-use absorbent sheet 1, the portion where the tissue 3 covers the absorption member 4 has the unevenness part 10, and the ratio of the weight of the water-absorbent polymer materials 8 to the weight of the pulp materials 7 in the absorption member 4 is less than 1. Thus, a liquid that has permeated through the top side of the pet-use absorbent sheet 1 is diffused into the sheet more quickly than in the reference example, and thereby the liquid is less likely to remain on the side near the top side of the top side sheet 2 or the absorption member 4. Accordingly, a wider diffusion range and a less wetback amount than those in the reference example can be ensured, and the amount of the water-absorbent polymer per product can be reduced, which is advantageous in terms of costs. The diffusion range can be made wider and the wetback amount can be made less than those in the reference example, this suppresses soles of a pet from getting wet when the pet walks on a urinated portion on the pet-use absorbent sheet 1, and it is thus possible to prevent the dampness from spreading wider to other regions. Even when the pet moves out of the pet-use absorbent sheet 1 and walks around in the room, it is possible to prevent the room from getting wet or dirty. It is also possible to reduce the amount of odor generated from urine or the like and leaking out of the pet-use absorbent sheet 1.

Since the unevenness part 10 is formed of the recesses 11 and the protrusions 12 and a liquid can flow in the recesses 11, a liquid that has permeated through the top side sheet 2 and entered the inside of the pet-use absorbent sheet 1 is guided to the recesses 11 of the unevenness part 10 and quickly diffused into the absorption member 4. Accordingly, even when a pet has urinated multiple times on the pet-use absorbent sheet 1, the liquid can be diffused over substantially the same range as the range where the liquid was first diffused. This enables the top side sheet 2 to maintain substantially the same dry texture as that after the first urination. Therefore, the pet-use absorbent sheet 1 can be used multiple times, rather than being disposed for only one time urination, and the waste can be reduced.

Since the tissue 5 is further arranged between the absorption member 4 and the backside sheet 6 in the pet-use absorbent sheet 1, the amount of a liquid absorbed inside the pet-use absorbent sheet 1 can be increased. Accordingly, dampness on the top side of the sheet can be reduced more quickly than in the reference example, and dry texture of the top side sheet 2 can be maintained.

### EXAMPLE

Experiments were performed to compare the pet-use absorbent sheet of the above embodiment with a commercially available conventional pet-use absorbent sheet in terms of the liquid diffusion range and the wetback amount when a liquid was added to the pet-use absorbent sheets (hereafter, referred to as “absorbent sheet”). Based on the comparison on the liquid diffusion range, it is possible to make a comparison on the range that the liquid is diffused within a certain period of time in the absorbent sheet that has absorbed urine or the like, that is, a comparison on the diffusion rate. Based on the comparison on the wetback amount, it is possible to make a comparison on the amount of moisture remaining on the surface of the absorbent sheet after urine has permeated in the absorbent sheet, that is, a comparison on a difference in dry texture after use.

The pet-use absorbent sheet according to the present embodiment was used for Test piece 1 and Test piece 2, and a commercially available pet-use absorbent sheet was used for Test piece 3 as a control product. In the absorbent sheets of Test piece 1 and Test piece 2, the unevenness part is formed by embossing the tissue and the absorption member, and the top side sheet is attached thereto from above. As indicated in Table 1, the absorbent sheets having substantially the same size were used for Test piece 1, Test piece 2, and Test piece 3, and the weights of the products are within a range of 22 g to 28 g. On the other hand, with respect to the amount of the water-absorbent polymer material, Test piece 1 and Test piece 2 according to the present embodiment contained 4.3 g and 4.5 g, respectively, and Test piece 3 contained 7.5 g. With respect to the amount of the pulp material, Test piece 1 contained 11.0 g, Test piece 2 contained 14.8 g, and Test piece 3 contained 5.1 g. In other words, while the ratio by weight of the water-absorbent polymer material to the pulp material in Test piece 1 and Test piece 2 according to the present embodiment were 0.39 and 0.30, respectively, the ratio was 1.47 in Test piece 3. That is, the ratio by weight of the water-absorbent polymer material to the pulp material of Test piece 3 was about 3.0 to 4.8 times that of Test pieces 1 and 2. The pitch of the unevenness part was 7 mm in both the vertical direction and the horizontal direction in the drawing sheet of FIG. 1.

### Test 1-1. Comparison on Diffusion Range

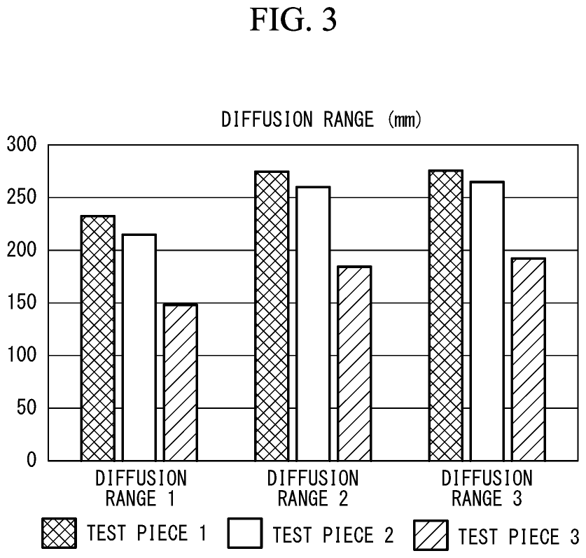

For the sheets of Test pieces 1 to 3, 50 mL of colored saline solution was added to the center part of each absorbent sheet by using a cylinder, and the distance by which the liquid was diffused on the top side sheet of each absorbent sheet was then measured after a predetermined period of time passed from the addition. The distance by which the liquid was diffused was evaluated as “diffusion range”. In Table 1, “Diffusion range 1” to “Diffusion range 3” are the results obtained by performing three times of test to add 50 mL of saline solution to each center part of the absorbent sheet and measure the diffusion distance after three minutes passed. The results for respective test pieces are shown in Table 1 and FIG. 3.

### Test 1-2. Comparison on Wetback Amount

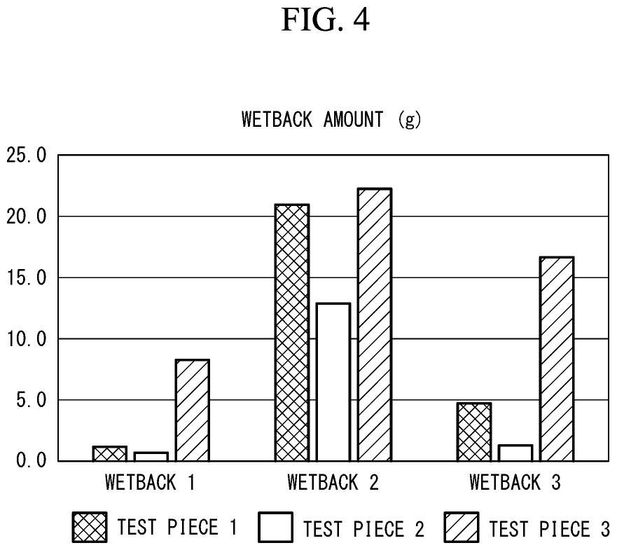

The absorbent sheets of Test pieces 1 to 3 were used, 50 mL of colored saline solution was added to the center part of each absorbent sheet, filter paper was pressed at a certain pressure against the top side sheet of each absorbent sheet after a predetermined period of time passed from the addition, and the amount of moisture transferred to the filter paper was measured. The amount of moisture transferred to the filter paper was evaluated as “wetback amount”. In Table 1, “Wetback 1” represents the weight (g) measured after 3 minutes from the addition of the saline solution, “Wetback 2” represents the weight (g) measured after transferred to filter paper after 3 minutes passed from further addition of 50 mL of saline solution after 10 minutes from the addition of the saline solution, and “Wetback 3” represents the weight (g) measured after transferred to filter paper after 10 minutes passed from further addition of 50 mL of saline solution after 10 minutes from the addition of the saline solution. The results for respective test pieces are shown in Table 1, FIG. 3, and FIG. 4.

TABLE 1

| | Present embodiment | | Control product |
|---|---|---|---|
| No. | Test piece 1 | Test piece 2 | Test piece 3 |
| Product weight (g) | 24.0 | 28.0 | 22.1 |
| Water-absorbent polymer | 4.3 | 4.5 | 7.5 |
| weight (g) | | | |
| Pulp weight (g) | 11.0 | 14.8 | 5.1 |
| SAP weight/pulp weight | 39.1% | 30.4% | 147.1% |
| Wetback 1 | 1.2 | 0.7 | 8.3 |
| Wetback 2 | 21.0 | 12.9 | 22.3 |
| Wetback 3 | 4.8 | 1.3 | 16.7 |
| Diffusion range 1 | 234 mm | 215 mm | 148 mm |
| Diffusion range 2 | 275 mm | 260 mm | 185 mm |
| Diffusion range 3 | 275 mm | 265 mm | 193 mm |

The values of Diffusion ranges 1 to 3 were compared between Test piece 1 and Test piece 2 according to the present embodiment and commercially available Test piece 3. The result is shown in FIG. 3. The values were 234 mm to 275 mm for Test piece 1 and 215 mm to 265 mm for Test piece 2, that is, the diffusion ranges were spread 1.5 times larger than the value 148 mm to 193 mm for Test piece 3 that is the control product.

The result of the comparison for the value of Wetback 1 is shown in FIG. 4. The wetback amount after one time of absorption was 1.2 g in Test piece 1 and 0.7 g in Test piece 2 and was 8.3 g in Test piece 3 that is the control product. It was found from this result that, in Test piece 3, the amount of moisture of about 7 to 10 times that in Test piece 1 and Test piece 2 remained on the sheet surface after one time of absorption. In Wetback 2 (measured after 3 minutes after the second addition), there was little difference between Test piece 1 and Test piece 3. In Wetback 3 (measured after 10 minutes after the second addition), however, the value was 4.8 g for Test piece 1 and 1.3 g for Test piece 2, and the value was 16.7 g for Test piece 3. It was suggested from this result that 3.5 times to 10 times more moisture remained on the sheet surface of Test piece 3 than in Test piece 1 and Test piece 2.

### Test 2

Experiments were performed to compare the absorbent sheet of the present embodiment with the commercially available absorbent sheet in terms of the liquid diffusion range and the wetback amount when a liquid was added to the pet-use absorbent sheets for three times.

Test piece 4 is the pet-use absorbent sheet according to the present embodiment, and Test piece 5 is the same as Test piece 3 used in Tests 1-1 and 1-2. Test piece 4 and Test piece 5 are substantially the same in size and product weight and differ only in the ratio by weight of the pulp and the water-absorbent polymer.

With the same procedure as in Tests 1-1 and 1-2, 50 mL of colored saline solution was added to the center part of each absorbent sheet, filter paper was pressed at a certain pressure against the top side sheet of each absorbent sheet after a predetermined period of time passed from the addition, and the amount of moisture transferred to the filter paper was measured as one step, and this step was repeated two times, that is, the saline solution was added three times in total.

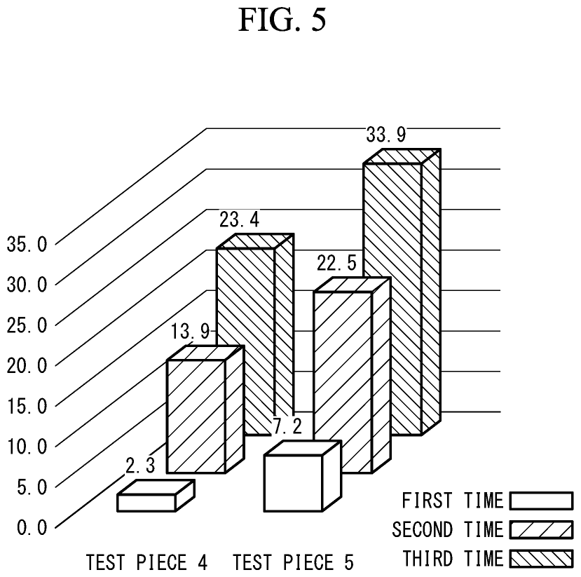

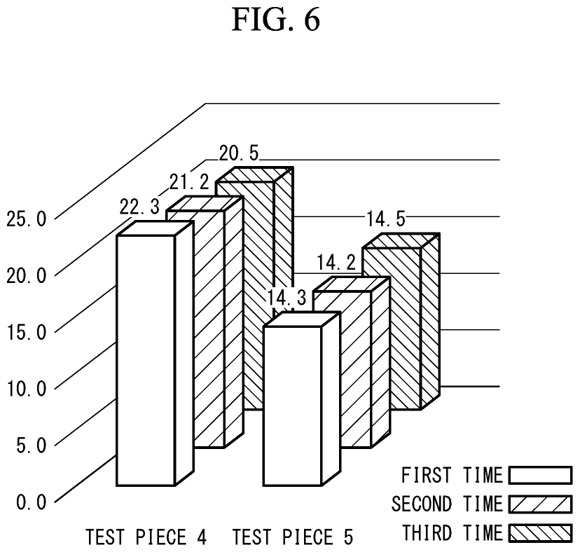

The result of the comparison on the wetback amount is shown in FIG. 5, and the result of comparison on the diffusion range is shown in FIG. 6. The unit of the vertical axis of FIG. 5 is gram (g), and the unit of the vertical axis of FIG. 6 is centimeter (cm). It was found that, with the use of Test piece 4, the wetback amount was less than that of the commercially available control product (Test piece 5) in all the times from the first addition to the third addition. Since the wetback amount for the second time with the control product (Test piece 5) and the wetback amount for the third time with Test piece 4 were at substantially the same level, it was confirmed that the small wetback amount in the test pieces according to the present embodiment is remarkable. It was also found for the diffusion range that, in Test piece 4, the liquid was diffused to a distance of about 1.5 times the diffusion range in Test piece 5 in all the first to third times of addition. It was confirmed that, in Test piece 4 of the present example, a liquid absorbed in the absorbent sheet can be diffused more quickly than in commercially available Test piece 5.

As described above, it was confirmed that the pet-use absorbent sheet according to the present embodiment can achieve a higher diffusion rate after liquid absorption and a less wetback amount than the control product by virtue of a suitable combination of the unevenness part provided in the absorbent sheet and the amounts of water-absorbent polymer and pulp material.

Note that the thickness of each layer represented in the drawings is an example for illustrating the pet-use absorbent sheet according to the present embodiment and is not intended to define the thickness in an actual product. For example, although the tissue 3 and the tissue 5 differ in thickness from each other in FIG. 2A, those having the same thickness may be used, or the tissue 3 may be thicker than the tissue 5.

### REFERENCE SIGNS LIST

1 pet-use absorbent sheet
2 top side sheet (top side layer)
3 tissue (tissue layer)
4 absorption member
5 tissue (tissue layer)
6 backside sheet (backside layer)
7 pulp material
8 water-absorbent polymer material
10 embossed part (unevenness part)
11 recess
12 protrusion
15 edge part

1. A pet-use absorbent sheet comprising:
a liquid-permeable top side layer;
a liquid-impermeable backside layer;
an absorption member arranged between the top side layer and the backside layer and configured to absorb a liquid that permeated through the top side layer; and
a tissue layer arranged between the top side layer and the absorption member,
wherein a portion where the top side layer and the tissue layer cover the absorption member has an unevenness part,
wherein the absorption member contains a pulp material and a water-absorbent polymer material, and
wherein the ratio of the weight of the water-absorbent polymer material to the weight of the pulp material in the absorption member is less than 1.

2. The pet-use absorbent sheet according to claim 1, wherein the unevenness part is formed of a recess and a protrusion, and the recess is configured to allow a liquid to flow in the recess.

3. The pet-use absorbent sheet according to claim 1, wherein a tissue layer is further arranged between the absorption member and the backside layer.
